(19) United States
(12) Patent Application Publication
(10) Pub. No.: US 2026/0302050 A1
(43) Pub. Date: Oct. 1, 2026

(54) INDUCTOR AND DC-DC CONVERTER

(71) Applicant: TDK Corporation, Tokyo (JP)

(72) Inventors: Tomofumi KURODA, Tokyo (JP); Hajime KUWAJIMA, Tokyo (JP); Naoya HIEDA, Tokyo (JP); Haruka AIBA, Tokyo (JP)

(73) Assignee: TDK Corporation, Tokyo (JP)

(21) Appl. No.: 19/630,553

(22) Filed: Mar. 27, 2026

(30) Foreign Application Priority Data
Mar. 31, 2025 (JP) 2025-057986

(51) Int. Cl. H01F 27/29; H01F 27/24

(52) U.S. Cl. CPC H01F 27/29; H01F 27/24

(57) ABSTRACT

An inductor includes an element body configured with an element body material containing resin, a magnetic block provided in the element body, a coil conductor provided in the element body, and a terminal portion extending from an end portion on a lower surface side of a conductor portion of the coil conductor to a first side surface side of the element body to face a lower surface of the magnetic block. A gap between the lower surface of the magnetic block and the terminal portion is filled with the element body material constituting the element body. Therefore, under a situation where the magnetic block thermally expands in a second direction under a high-temperature environment, the magnetic block does not directly press the terminal portion downward, and a situation where the crack occurs in the element body is suppressed.

### CROSS-REFERENCE TO RELATED APPLICATIONS

This application is based upon and claims the benefit of priority from Japanese Patent Application No. 2025-57986, filed on 31 Mar. 2025, the entire contents of which are incorporated herein by reference.

### TECHNICAL FIELD

The present disclosure relates to an inductor and a DC-DC converter.

### BACKGROUND

Japanese Patent Application Publication No. 2024-93473 discloses an inductor having a configuration in which a coil conductor and a magnetic body are arranged side by side in an element body composed of magnetic powder-containing resin. Then, a terminal portion extending from the coil conductor is exposed on a mounting surface of the element body facing a circuit board on which the inductor is surface-mounted.

### SUMMARY

In the above-described inductor, when the terminal portion is configured to extend toward the magnetic body side in the vicinity of the mounting surface, a configuration in which the magnetic body is directly placed on the terminal portion may be obtained. In such a configuration, when the magnetic body thermally expands in a direction orthogonal to the mounting surface under a high-temperature environment, the terminal portion is pressed downward by the magnetic body, and as a result, it is conceivable that a crack occurs in the element body.

According to various aspects of the present disclosure, an inductor and a DC-DC converter in which occurrence of cracks is suppressed are provided.

An inductor according to one aspect of the present disclosure includes an element body having a first side surface and a second side surface facing each other in a first direction, and a first main surface and a second main surface facing each other in a second direction orthogonal to the first direction, and composed of an element body material containing resin, a first magnetic body provided in the element body and having a first surface and a second surface facing each other in the first direction, and a third surface and a fourth surface facing each other in the second direction, the first surface faces the first side surface side, the second surface faces the second side surface side, the third surface faces the first main surface side, and the fourth surface faces the second main surface side, a first coil conductor provided in the element body, at least a part of the first coil conductor faces the second surface of the first magnetic body, and a first terminal portion extending from an end portion on the first main surface side of the first coil conductor to the first side surface side to face the third surface of the first magnetic body, and at least a part of the first terminal portion is exposed from the first main surface of the element body. A gap between the third surface of the first magnetic body and the first terminal portion is filled with the element body material.

A DC-DC converter according to one aspect of the present disclosure includes the inductor.

### BRIEF DESCRIPTION OF THE DRAWINGS

FIG. 1 is a perspective view of an inductor according to one embodiment.

FIG. 2 is an exploded view of the inductor shown in FIG. 1.

FIG. 4 is a side view of the inductor shown in FIG. 1.

FIG. 5 is a diagram showing a crack that may occur in a side surface of an inductor.

FIG. 6 is a cross-sectional view showing an inductor of a mode different from FIG. 3.

FIG. 7 is a diagram showing a circuit of a DC-DC converter in which the inductor shown in FIG. 1 is used.

### DETAILED DESCRIPTION

Hereinafter, some embodiments of the present disclosure will be described in detail. However, the present disclosure is not limited to the following embodiments.

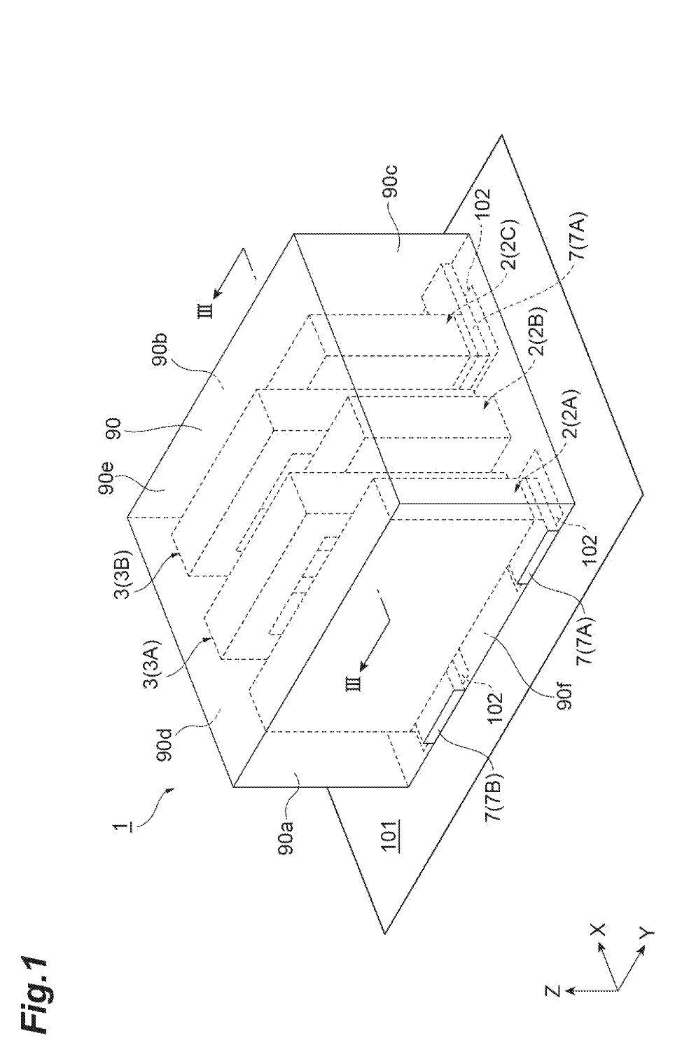

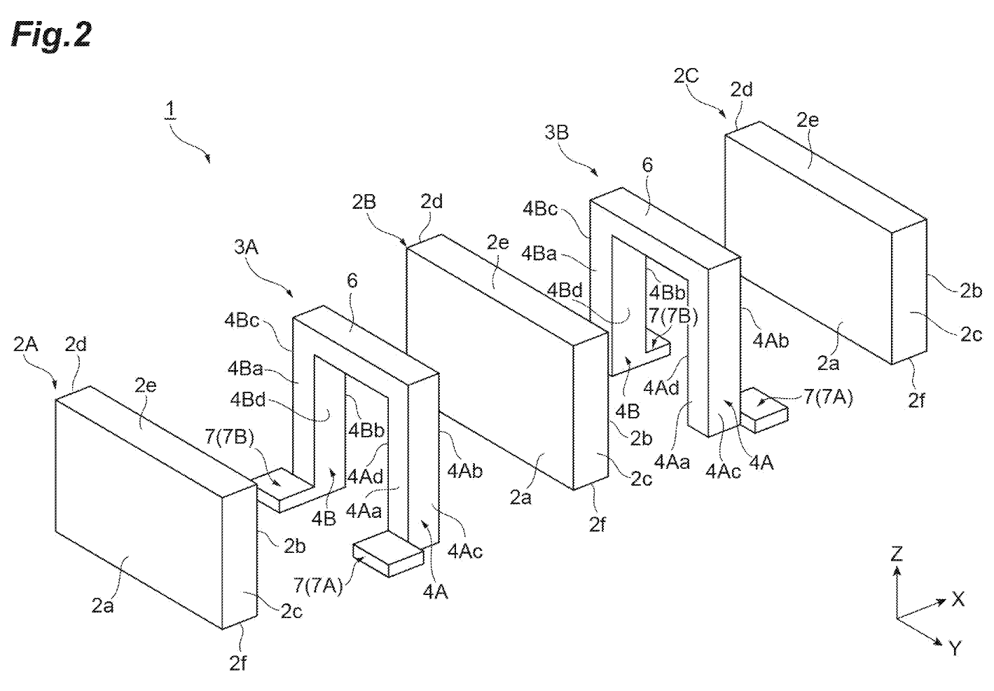

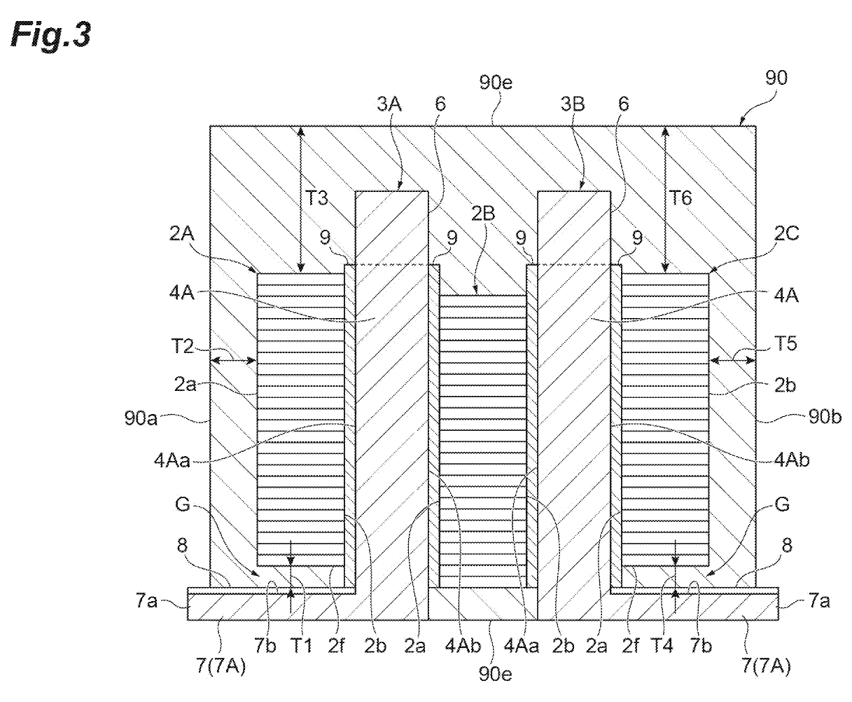

First, a schematic configuration of an inductor 1 in the present embodiment will be described with reference to FIGS. 1 and 2. FIG. 1 is a perspective view of the inductor 1 in the present embodiment. FIG. 2 is an exploded view of the inductor 1. FIG. 1 shows a state in which the inductor 1 is mounted on a substrate 101. The inductor 1 in the present embodiment is configured to include an element body 90, and magnetic blocks 2, coil conductors 3, and terminal portions 7 provided in the element body 90, and more specifically, is configured to include three magnetic blocks 2 serving as cores, a pair of coil conductors 3, and a pair of terminal portions 7 corresponding to each of the pair of coil conductors 3. That is, the inductor 1 according to the present embodiment is a composite inductor provided with two inductors.

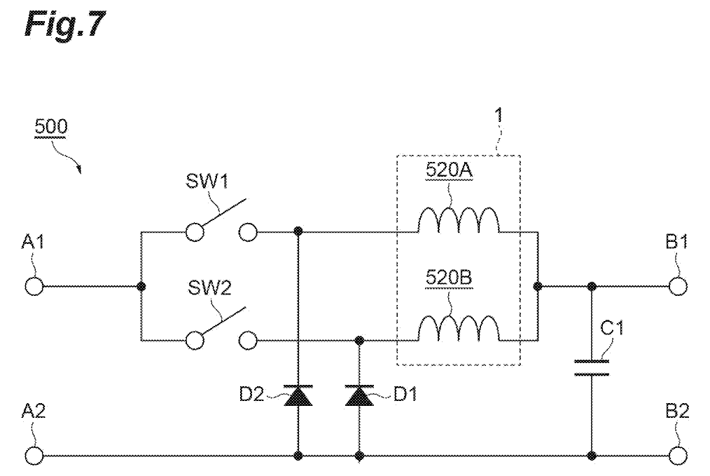

The pair of coil conductors 3 (i.e. the coil conductors 3A and 3B) included in the inductor 1 can be adopted for each choke coil of a circuit of a DC-DC converter 500 shown in FIG. 7. The DC-DC converter 500 is a multi-phase converter including a pair of conversion units formed by switching elements SW1, SW2, choke coils 520A, 520B, and diodes D1, D2, wherein these conversion units are connected in parallel, and the inductor 1 can be adopted as the choke coils 520A, 520B of each conversion unit. Describing the configuration of the DC-DC converter 500 in more detail, the DC-DC converter 500 includes a pair of input terminals A1, A2, a pair of output terminals B1, B2, a switching element SW1 and a choke coil 520A connected in series in this order between the input terminal A1 and the output terminal B1, a switching element SW2 and a choke coil 520B connected in series in this order between the input terminal A1 and the output terminal B1, and a capacitor C1 connected between the output terminals B1, B2. A circuit consisting of the switching element SW1 and the choke coil 520A, and a circuit consisting of the switching element SW2 and the choke coil 520B are connected in parallel between the input terminal A1 and the output terminal B1. The input terminal A2 and the output terminal B2 constitute a ground line. The diode D2 is connected in a reverse direction between a connection point of the switching element SW1 and the choke coil 520A and the ground line, and the diode D1 is connected in a reverse direction between a connection point of the switching element SW2 and the choke coil 520B and the ground line. The switching elements SW1, SW2 are alternately turned on and off by a control circuit (not shown), whereby an output voltage obtained by stepping down an input voltage is generated. By configuring the pair of choke coils 520A, 520B in the DC-DC converter 500 with the pair of coil conductors 3A, 3B of the inductor 1, it is possible to reduce the number of components constituting the DC-DC converter 500.

As shown in FIG. 1, the element body 90 has a substantially rectangular parallelepiped outer shape. In the present embodiment, the outer shape of the element body 90 is configured by three pairs of surfaces facing each other in an X-axis direction, a Y-axis direction, and a Z-axis direction which are orthogonal to each other. That is, the outer shape of the element body 90 has a first side surface 90a and a second side surface 90b facing each other in the X-axis direction, a third side surface 90c and a fourth side surface 90d facing each other in the Y-axis direction, and an upper surface 90e (second main surface) and a lower surface 90f (first main surface) facing each other in the Z-axis direction. The X-axis direction corresponds to a "first direction" in the claims, the Z-axis direction corresponds to a "second direction" in the claims, and the Y-axis direction corresponds to a "third direction" in the claims. The rectangular parallelepiped outer shape includes a rectangular parallelepiped shape in which corner portions and ridge line portions are chamfered, and a rectangular parallelepiped shape in which corner portions and ridge line portions are rounded. Further, since the terminal portions 7 are exposed from the lower surface 90f of the element body 90 as in the present embodiment, a step is generated on the lower surface 90f of the element body 90, but the rectangular parallelepiped outer shape also includes the element body 90 including such a step.

The element body 90 is configured with an element body material containing resin, and a thermosetting resin such as epoxy can be adopted as the resin of the element body material. The element body material according to the present embodiment contains a magnetic material, and contains magnetic powder as the magnetic material. More specifically, the element body material according to the present embodiment is configured with a mixture of soft magnetic metal powder and resin, and is, for example, a composite material in which soft magnetic metal powder is dispersed in binder resin. As the soft magnetic metal powder, an iron-silicon alloy, permalloy, sendust, amorphous, nanocrystalline alloy, or a mixture thereof can be used. Further, when the element body material contains magnetic powder, the permeability of the element body material may be 5 or more, and may be 20 or more. Furthermore, the permeability of the element body material may be 100 or less, and may be 50 or less. The element body material may have a lower permeability than the magnetic block 2.

The three magnetic blocks 2 are configured with a first magnetic block 2A, a second magnetic block 2B, and a third magnetic block 2C. The magnetic block 2A and the magnetic block 2B are arranged in a state of being spaced apart from and facing each other in the X-axis direction. The magnetic block 2B and the magnetic block 2C are arranged in a state of being spaced apart from and facing each other in the X-axis direction. The magnetic blocks 2A, 2B, 2C are arranged in this order from the negative side in the X-axis direction. The magnetic block 2 has a substantially rectangular parallelepiped outer shape. In the present embodiment, it has a rectangular parallelepiped shape that is flat in the X-axis direction. The magnetic blocks 2 may have the same shape. Each of the first magnetic block 2A, the second magnetic block 2B, and the third magnetic block 2C may have a mutually different shape, or the first magnetic block 2A and the third magnetic block 2C may have the same shape, and the first magnetic block 2A and the third magnetic block 2C and the second magnetic block 2B may have different shapes. Further, the magnetic block 2 may have a shape other than a rectangular parallelepiped.

The magnetic block 2 according to the present embodiment is a laminated magnetic core having a laminated structure in which a plurality of soft magnetic metal plates are laminated in the Z-axis direction via resin layers. The number of layers of the soft magnetic metal plates constituting the magnetic block 2 is 120 layers as an example. The soft magnetic metal plate can be configured with, for example, a magnetic alloy such as an amorphous alloy, a microcrystalline alloy, permalloy, or an alloy having a nano-heterostructure. Examples of the amorphous alloy material include an Fe-based amorphous soft magnetic material and a Co-based amorphous soft magnetic material, and examples of the microcrystalline alloy include an Fe-based nanocrystalline soft magnetic material. The nano-heterostructure refers to a structure in which microcrystals exist in an amorphous material. Materials such as epoxy resin, polyimide resin, polyimide amide resin, and silicone resin can be adopted for the resin layer included in the magnetic block 2. The magnetic block 2 can be configured to have a relatively high permeability, and can be designed to have a higher permeability than the permeability of the element body material constituting the element body 90. The permeability of the magnetic block 2 may be 1000 or more. Further, the magnetic blocks 2 may have substantially the same magnetic characteristics or may have different magnetic characteristics. Since the magnetic block 2 has a laminated structure in which a plurality of soft magnetic metal plates are laminated in the Z-axis direction via resin layers, a thermal expansion coefficient in the Z-axis direction is larger than thermal expansion coefficients in the X-axis direction and the Y-axis direction.

Each of the three magnetic blocks 2A to 2C has a pair of main surfaces 2a and 2b, a pair of end surfaces 2c and 2d, and a pair of side surfaces 2e and 2f. The pair of main surfaces 2a and 2b face each other in the X-axis direction. The main surface 2a is arranged on the negative side in the X-axis direction which is the first side surface 90a side of the element body 90, and the main surface 2b is arranged on the positive side in the X-axis direction which is the second side surface 90b side of the element body 90. The pair of end surfaces 2c and 2d face each other in the Y-axis direction. The end surface 2c is arranged on the positive side in the Y-axis direction, and the end surface 2d is arranged on the negative side in the Y-axis direction. The pair of side surfaces 2e and 2f face each other in the Z-axis direction. The side surface 2e corresponds to an upper surface of the magnetic block arranged on the positive side in the Z-axis direction which is the upper surface 90e side of the element body 90, and the side surface 2f corresponds to a lower surface of the magnetic block arranged on the negative side in the Z-axis direction which is the lower surface 90f side of the element body 90. The facing direction of the pair of main surfaces 2a and 2b may completely coincide with the X-axis direction, or may be inclined to some extent from the X-axis direction. The facing direction of the pair of end surfaces 2c and 2d may completely coincide with the Y-axis direction, or may be inclined to some extent from the Y-axis direction. The facing direction of the pair of side surfaces 2e and 2f may completely coincide with the Z-axis direction, or may be inclined to some extent from the Z-axis direction.

The two coil conductors 3 are configured with a first coil conductor 3A and a second coil conductor 3B. The first coil conductor 3A and the second coil conductor 3B are arranged along the X-axis direction with the second magnetic block 2B interposed therebetween. The first coil conductor 3A is arranged between the first magnetic block 2A and the second magnetic block 2B, and the second coil conductor 3B is arranged between the second magnetic block 2B and the third magnetic block 2C. The material of the coil conductor 3 is configured with a metal selected from, for example, Cu, Ag, Au, Al, Ni, Sn, and the like.

The first coil conductor 3A includes a pair of conductor portions 4A and 4B and a connecting portion 6. The pair of conductor portions 4A and 4B correspond to a "first conductor portion" and a "second conductor portion" in the claims, respectively, and the connecting portion 6 corresponds to a "connection conductor portion" in the claims.

Both of the conductor portions 4A and 4B extend in the Z-axis direction and are parallel to each other. The conductor portions 4A and 4B are arranged between the first magnetic block 2A and the second magnetic block 2B in the X-axis direction. The conductor portion 4A is arranged on the positive side in the Y-axis direction, and the conductor portion 4B is arranged on the negative side in the Y-axis direction. The conductor portions 4A and 4B do not have to be parallel to the Z-axis direction as long as they extend in the Z-axis direction.

The conductor portion 4A has a pair of facing surfaces 4Aa and 4Ab and a pair of side surfaces 4Ac and 4Ad. The pair of facing surfaces 4Aa and 4Ab face each other in the X-axis direction. The facing surface 4Aa arranged on the negative side in the X-axis direction faces the first magnetic block 2A in the X-axis direction. The facing surface 4Ab arranged on the positive side in the X-axis direction faces the second magnetic block 2B in the X-axis direction. The side surfaces 4Ac and 4Ad face each other in the Y-axis direction. The side surface 4Ac is arranged on the positive side in the Y-axis direction, and the side surface 4Ad is arranged on the negative side in the Y-axis direction. The conductor portion 4B has a pair of facing surfaces 4Ba and 4Bb and a pair of side surfaces 4Bc and 4Bd. The pair of facing surfaces 4Ba and 4Bb face each other in the X-axis direction. The facing surface 4Ba arranged on the negative side in the X-axis direction faces the first magnetic block 2A in the X-axis direction. The facing surface 4Bb arranged on the positive side in the X-axis direction faces the second magnetic block 2B in the X-axis direction. The side surfaces 4Bc and 4Bd face each other in the Y-axis direction. The side surface 4Bc is arranged on the negative side in the Y-axis direction, and the side surface 4Bd is arranged on the positive side in the Y-axis direction.

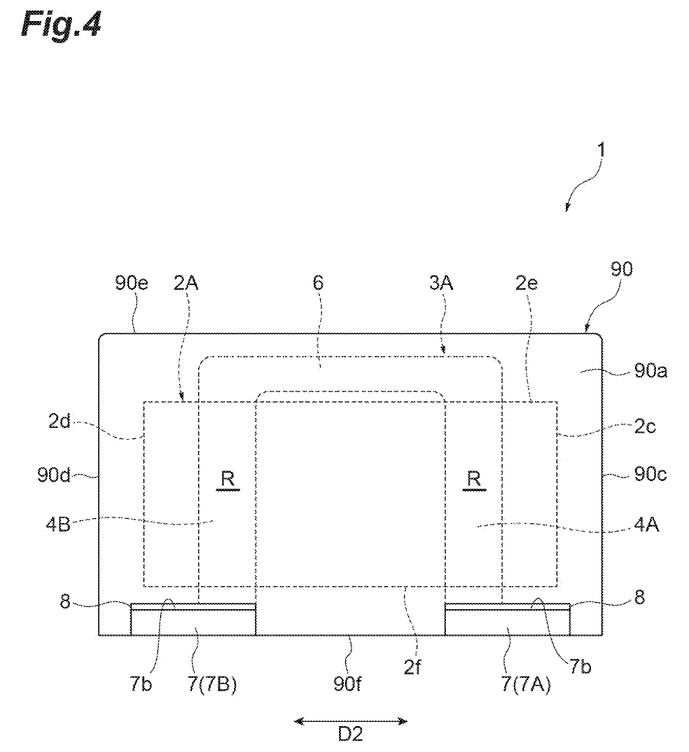

The connecting portion 6 is a member that connects the conductor portion 4A and the conductor portion 4B. The connecting portion 6 is connected to one ends (i.e., ends on the positive side in the Z-axis direction) of the conductor portions 4A and 4B, and extends in the Y-axis direction. The connecting portion 6 does not have to be parallel to the Y-axis direction as long as it extends in the Y-axis direction. In the present embodiment, as shown in FIG. 4, the side surface 2e of the first magnetic block 2A is located closer to the lower surface 90f side (i.e., negative side in the Z-axis direction) than the lower surface (i.e., the surface on the negative side in the Z-axis direction) of the connecting portion 6.

A pair of terminal portions 7 are connected to the first coil conductor 3A. The pair of terminal portions 7 may be provided integrally with the first coil conductor 3A, or may be provided as separate bodies. The pair of terminal portions 7 connected to the first coil conductor 3A correspond to "first terminal portions" in the claims, respectively. The pair of terminal portions 7 are configured with a terminal portion 7A and a terminal portion 7B. The terminal portion 7A is connected to the first coil conductor 3A, provided at the other end (i.e., the end on the negative side in the Z-axis direction) of the conductor portion 4A, and extends to the negative side in the X-axis direction and the positive side in the Y-axis direction. The terminal portion 7A is configured by forming a part near the other end of the conductor portion 4A so as to be wide toward the positive side in the Y-axis direction, and bending the wide portion toward the negative side in the X-axis direction. The terminal portion 7B is connected to the other end (i.e., the end on the negative side in the Z-axis direction) of the conductor portion 4B of the first coil conductor 3A, and extends to the negative side in the X-axis direction and the negative side in the Y-axis direction. The terminal portion 7B is configured by forming a part near the other end of the conductor portion 4B so as to be wide toward the negative side in the Y-axis direction, and bending the wide portion toward the negative side in the X-axis direction. The terminal portions 7A and 7B connected to the first coil conductor 3A extend to the first side surface 90a passing through the lower surface 2f side of the first magnetic block 2A adjacent to the first coil conductor 3A on the negative side in the X-axis direction, and end portions 7a located on the negative side in the X-axis direction are exposed from the first side surface 90a. As shown in FIG. 4, the terminal portions 7A and 7B exposed at the first side surface 90a exhibit a substantially rectangular shape extending along the Y-axis direction. The terminal portions 7A and 7B connected to the first coil conductor 3A and the first magnetic block 2A are spaced apart in the Z-axis direction, and a gap G exists between upper surfaces 7b (i.e., surfaces on the positive side in the Z-axis direction) of the terminal portions 7A and 7B and the lower surface 2f of the magnetic block 2A which face each other in the Z-axis direction. The terminal portions 7A and 7B connected to the first coil conductor 3A are joined to land electrodes 102 of the substrate 101 on which the inductor 1 is mounted. Thereby, the inductor 1 is mounted on the substrate 101. As shown in FIG. 3, the terminal portions 7A and 7B exposed at the first side surface 90a may extend protruding from the first side surface 90a.

The second coil conductor 3B includes a pair of conductor portions 4A and 4B and a connecting portion 6, similarly to the first coil conductor 3A. A pair of terminal portions 7 are connected to the second coil conductor 3B. The pair of terminal portions 7 may be provided integrally with the second coil conductor 3B, or may be provided as separate bodies. The pair of terminal portions 7 connected to the second coil conductor 3B correspond to "second terminal portions" in the claims, respectively. The pair of terminal portions 7 are configured with a terminal portion 7A and a terminal portion 7B. The terminal portion 7A extends from the other end of the conductor portion 4A of the second coil conductor 3B to the positive side in the X-axis direction and the positive side in the Y-axis direction, and the terminal portion 7B extends from the other end of the conductor portion 4B of the second coil conductor 3B to the positive side in the X-axis direction and the negative side in the Y-axis direction. The terminal portions 7A and 7B connected to the second coil conductor 3B extend to the second side surface 90b passing through the lower surface 2f side of the third magnetic block 2C adjacent to the second coil conductor 3B on the positive side in the X-axis direction, and end portions 7a located on the positive side in the X-axis direction are exposed from the second side surface 90b. The terminal portions 7A and 7B exposed at the second side surface 90b exhibit a substantially rectangular shape extending along the Y-axis direction. The terminal portions 7A and 7B connected to the second coil conductor 3B and the third magnetic block 2C are spaced apart in the Z-axis direction, and a gap G exists between upper surfaces 7b (

i.e., surfaces on the positive side in the Z-axis direction) of the terminal portions 7A and 7B and the lower surface 2f of the magnetic block 2C which face each other in the Z-axis direction. The terminal portions 7A and 7B connected to the second coil conductor 3B are also joined to the land electrodes 102 of the substrate 101 on which the inductor 1 is mounted. As shown in FIG. 3, the terminal portions 7A and 7B exposed at the second side surface 90b may extend protruding from the second side surface 90b.

In both the terminal portions 7A and 7B connected to the first coil conductor 3A and the terminal portions 7A and 7B connected to the second coil conductor 3B, surfaces on the negative side in the Z-axis direction are exposed from the element body 90, and are joined to the land electrodes 102 at the exposed portions. Further, a part located on the negative side in the Z-axis direction in a surface adjacent to the surface on the negative side in the Z-axis direction of the terminal portions 7A and 7B connected to the first coil conductor 3A and the terminal portions 7A and 7B connected to the second coil conductor 3B may be exposed from the element body 90.

In both the terminal portions 7A and 7B connected to the first coil conductor 3A and the terminal portions 7A and 7B connected to the second coil conductor 3B according to the present embodiment, the upper surfaces 7b are covered with an insulation layer 8. The insulation layer 8 may cover the entire area of the upper surfaces 7b of the terminal portions 7A and 7B, or may cover a partial region. The insulation layer 8 may be configured with a material in which a filler is dispersed in epoxy resin, for example. A peel strength at an interface between the insulation layer 8 and the element body material may be configured to be higher than a peel strength at an interface between the insulation layer 8 and the terminal portions 7A and 7B. By thermally curing the element body material while the insulation layer 8 and the element body material are in close contact, the peel strength at the interface between the insulation layer 8 and the element body material can be increased. Deformation of the terminal portions 7A and 7B is suppressed by the element body material adhering to the terminal portions 7A and 7B via the insulation layer 8.

An adhesive 9 is interposed between each magnetic block 2 and each coil conductor 3 described above, and they are adhered to each other by the adhesive 9. Specifically, the adhesive 9 is provided on each of the facing surfaces 4Aa and 4Ab of the conductor portion 4A and the facing surfaces 4Ba and 4Bb of the conductor portion 4B of each coil conductor 3. More specifically, the adhesive 9 is provided in each facing region R facing the magnetic block 2 of the facing surfaces 4Aa, 4Ab, 4Ba, and 4Bb. The adhesive 9 can be provided in the facing region R using a known application technique using a nozzle or the like. The adhesive 9 may be configured with a material in which a filler is dispersed in resin. The filler may be a magnetic material or a non-magnetic material.

Next, surrounding of the magnetic blocks 2 and the coil conductors 3 by the element body material constituting the element body 90 will be described.

The element body material constituting the element body 90 integrally covers the three magnetic blocks 2A to 2C and the pair of coil conductors 3A, 3B. Regarding the first magnetic block 2A, all surface regions (i.e., remaining regions of the facing region R) excluding the facing region R between the first magnetic block 2A and the first coil conductor 3A (i.e., the region where the adhesive 9 is applied) are covered with the element body material. The element body material is also provided in the gap G between the lower surface 2f of the first magnetic block 2A and the upper surfaces 7b of the terminal portions 7A and 7B connected to the first coil conductor 3A described above. Specifically, the gap G is substantially filled with the element body material constituting the element body 90. Since the element body material contains resin, voids may occur accidentally due to entrainment of air or the like during its flow, but even when such a void in the element body material is located in the gap G, it can be considered that the gap G is filled with the element body material constituting the element body 90. The thickness of the gap G (i.e., the length in the Z-axis direction) substantially matches a thickness T1 of the element body material covering the lower surface 2f of the first magnetic block 2A in the gap G. The thickness T1 of the element body material covering the lower surface 2f of the first magnetic block 2A may be equal to or greater than the thickness of the terminal portions 7A and 7B connected to the first coil conductor 3A. When the adhesive 9 is partially provided to the facing region R between the first magnetic block 2A and the first coil conductor 3A, the main surface 2b of the first magnetic block 2A that is not covered with the adhesive 9 in the facing region R is included in the remaining regions of the facing region R.

The element body material covers the entire area of the main surface 2a of the first magnetic block 2A facing the first side surface 90a of the element body 90. A thickness T2 of the element body material covering the main surface 2a of the first magnetic block 2A may be the same as or different from the thickness T1 of the element body material covering the lower surface 2f of the first magnetic block 2A in the gap G. In the present embodiment, the thickness T2 of the element body material covering the main surface 2a of the first magnetic block 2A is designed to be thicker than the thickness T1 of the element body material covering the lower surface 2f of the first magnetic block 2A in the gap G (T2 > T1). The element body material covers the entire area of the upper surface 2e of the first magnetic block 2A facing the upper surface 90e of the element body 90. A thickness T3 of the element body material covering the upper surface 2e of the first magnetic block 2A may be the same as or different from the thickness T1 of the element body material covering the lower surface 2f of the first magnetic block 2A in the gap G. In the present embodiment, the thickness T3 of the element body material covering the upper surface 2e of the first magnetic block 2A is designed to be thicker than the thickness T1 of the element body material covering the lower surface 2f of the first magnetic block 2A in the gap G (T3 > T1). In the present embodiment, of the surfaces 2a to 2f of the first magnetic block 2A covered with the element body material, the thickness of the element body material covering the lower surface 2f of the first magnetic block 2A in the gap G is the thinnest, and the thickness of the element body material on the surfaces other than the lower surface 2f in the gap G is thicker than the thickness T1 of the element body material covering the lower surface 2f in the gap G. Further, the thickness of the element body material covering the surface other than the gap G in the lower surface 2f of the first magnetic block 2A ( i.e., the remaining region of the facing region with the terminal portions 7A and 7B in the lower surface 2f of the first magnetic block 2A) is thicker than the thickness T1 of the element body material covering the lower surface 2f of the first magnetic block 2A in the gap G.

Regarding the third magnetic block 2C, all surface regions (i.e., remaining regions of the facing region R) excluding the facing region R between the third magnetic block 2C and the second coil conductor 3B (i.e., the region where the adhesive 9 is applied) are covered with the element body material. The element body material is also provided in the gap G between the lower surface 2f of the third magnetic block 2C and the upper surfaces 7b of the terminal portions 7A and 7B connected to the second coil conductor 3B described above. Specifically, the gap G is substantially filled with the element body material constituting the element body 90. The thickness of the gap G (i.e., the length in the Z-axis direction) substantially matches a thickness T4 of the element body material covering the lower surface 2f of the third magnetic block 2C in the gap G. The element body material covers the entire area of the main surface 2b of the third magnetic block 2C facing the second side surface 90b of the element body 90. A thickness T5 of the element body material covering the main surface 2b of the third magnetic block 2C may be the same as or different from the thickness T4 of the element body material covering the lower surface 2f of the third magnetic block 2C in the gap G. In the present embodiment, the thickness T5 of the element body material covering the main surface 2b of the third magnetic block 2C is designed to be thicker than the thickness T4 of the element body material covering the lower surface 2f of the third magnetic block 2C in the gap G (T5 > T4). The element body material covers the entire area of the upper surface 2e of the third magnetic block 2C facing the upper surface 90e of the element body 90. A thickness T6 of the element body material covering the upper surface 2e of the third magnetic block 2C may be the same as or different from the thickness T4 of the element body material covering the lower surface 2f of the third magnetic block 2C in the gap G. In the present embodiment, the thickness T6 of the element body material covering the upper surface 2e of the third magnetic block 2C is designed to be thicker than the thickness T4 of the element body material covering the lower surface 2f of the third magnetic block 2C in the gap G (T6 > T4). In the present embodiment, of the surfaces 2a to 2f of the third magnetic block 2C covered with the element body material, the thickness of the element body material covering the lower surface 2f of the third magnetic block 2C in the gap G is the thinnest, and the thickness of the element body material on the surfaces other than the lower surface 2f in the gap G is thicker than the thickness T4 of the element body material covering the lower surface 2f in the gap G. Further, the thickness of the element body material covering the surface other than the gap G in the lower surface 2f of the third magnetic block 2C (i.e., the remaining region of the facing region with the terminal portions 7A and 7B in the lower surface 2f of the third magnetic block 2C) is thicker than the thickness T4 of the element body material covering the lower surface 2f of the third magnetic block 2C in the gap G.

The thickness T4 of the element body material covering the lower surface 2f of the third magnetic block 2C in the gap G may be the same as or different from the thickness T1 of the element body material covering the lower surface 2f of the first magnetic block 2A in the gap G. In the present embodiment, the thickness T4 of the element body material covering the lower surface 2f of the third magnetic block 2C in the gap G is the same as the thickness T1 of the element body material covering the lower surface 2f of the first magnetic block 2A in the gap G, and since the length in the Z-axis direction of the first magnetic block 2A and the length in the Z-axis direction of the third magnetic block 2C are the same, the first magnetic block 2A and the third magnetic block 2C are at the same position with respect to the Z-axis direction. In the present embodiment, the length in the Z-axis direction of the second magnetic block 2B is the same as the lengths in the Z-axis direction of the first magnetic block 2A and the third magnetic block 2C, but the second magnetic block 2B is at a position different from the first magnetic block 2A and the third magnetic block 2C with respect to the Z-axis direction, and specifically is at a position on the lower surface 90f side. In the present embodiment, the second magnetic block 2B is located closer to the lower surface 90f side of the element body 90 than the first magnetic block 2A and the third magnetic block 2C, but the lower surface 2f of the second magnetic block 2B is located closer to the upper surface 90e side of the element body 90 than the upper surfaces 7b of the terminal portions 7A and 7B facing the lower surface 2f of the magnetic block 2 in the Z-axis direction. That is, the upper surface 2e of the first magnetic block 2A is located closer to the upper surface 90e side of the element body 90 than the upper surface 2e of the second magnetic block 2B, and the lower surface 2f of the second magnetic block 2B is located closer to the lower surface 90f side of the element body 90 than the lower surface 2f of the first magnetic block 2A. Further, the upper surface 2e of the third magnetic block 2C is located closer to the upper surface 90e side of the element body 90 than the upper surface 2e of the second magnetic block 2B, and the lower surface 2f of the second magnetic block 2B is located closer to the lower surface 90f side of the element body 90 than the lower surface 2f of the third magnetic block 2C. The thickness T5 of the element body material covering the main surface 2b of the third magnetic block 2C may be the same as or different from the thickness T2 of the element body material covering the main surface 2a of the first magnetic block 2A. The thickness T6 of the element body material covering the upper surface 2e of the third magnetic block 2C may be the same as or different from the thickness T3 of the element body material covering the upper surface 2e of the first magnetic block 2A.

Regarding the second magnetic block 2B, all surfaces 2a to 2f excluding the facing region R between the second magnetic block 2B and the first coil conductor 3A and the second coil conductor 3B (i.e., the region where the adhesive 9 is applied) are covered with the element body material.

In the inductor 1, since the element body material is interposed in the gap G between the lower surface 2f of the magnetic block 2 and the upper surfaces 7b of the terminal portions 7A and 7B, the magnetic block 2 is not configured to be directly placed on the terminal portions 7A and 7B, and the lower surface 2f of the magnetic block 2 is not in direct contact with the upper surfaces 7b of the terminal portions 7A and 7B.

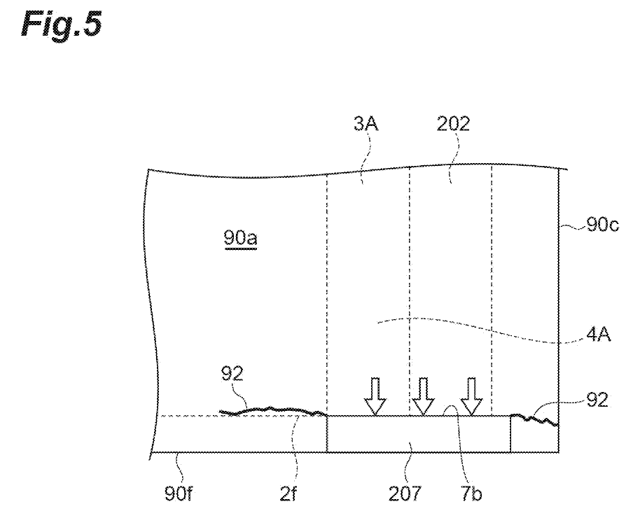

As shown in FIG. 5, in a configuration in which a magnetic block 202 similar to the magnetic block 2A described above is directly placed on a terminal portion 207 similar to the terminal portion 7A described above, under a situation where the magnetic block 202 thermally expands in the Z-axis direction under a high-temperature environment, the magnetic block 202 presses the terminal portion 207 downward (i.e., to the negative side in the Z-axis direction). When the magnetic block 202 is a laminated magnetic core laminated in the Z-axis direction, it is particularly easy to extend in the Z-axis direction. For example, at the time of reflow when mounting the inductor on a substrate, the inductor is placed in a high-temperature environment of around 260 degrees. At this time, a force in a direction of peeling from the element body 90 is applied to the terminal portion 207, so that a relatively large internal stress is generated in the element body 90 near the interface between the magnetic block 202 and the terminal portion 207, and a crack 92 extending from the interface between the magnetic block 202 and the terminal portion 207 may occur in the element body 90. When the crack 92 appears on the first side surface 90a of the element body 90, it is observed on the first side surface 90a. The crack 92 may also appear on the third side surface 90c (or the fourth side surface 90d) of the element body 90.

In the inductor 1 in which the element body material is interposed in the gap G between the lower surface 2f of the magnetic block 2 and the upper surfaces 7b of the terminal portions 7A and 7B, since the magnetic block 2 is not directly placed on the terminal portions 7A and 7B, the magnetic block 2 does not directly press the terminal portions 7A and 7B downward under a situation where the magnetic block 2 thermally expands in the Z-axis direction under a high-temperature environment. Thereby, the situation where the above-described crack 92 occurs in the element body 90 is suppressed. Actually, since the thermal expansion on the lower surface 2f side of the magnetic block 2 is suppressed to some extent by the element body material located in the gap G, the internal stress generated in the element body 90 near the interface between the magnetic block 2 and the terminal portions 7A and 7B is suppressed, so that the situation where the crack 92 due to the internal stress occurs is further suppressed.

Subsequently, operations and effects of the inductor 1 according to the present embodiment will be described.

The inductor 1 includes the element body 90 configured with the element body material containing resin, the magnetic block 2 provided in the element body 90, the coil conductor 3 provided in the element body 90, and the terminal portions 7A and 7B extending from the end portions on the lower surface 90f side of the conductor portions 4A and 4B of the coil conductor 3 to the first side surface 90a side of the element body 90 to face the lower surface 2f of the magnetic block 2, and the gap G between the lower surface 2f of the magnetic block 2 and the terminal portions 7A and 7B is filled with the element body material constituting the element body 90. Therefore, under a situation where the magnetic block 2 thermally expands in the Z-axis direction under a high-temperature environment, the magnetic block 2 does not directly press the terminal portions 7A and 7B downward, and the situation where the above-described crack 92 occurs in the element body 90 is suppressed.

The element body material does not cover the facing region R facing the coil conductor 3 of the surface regions of the magnetic block 2, but covers the remaining regions of the facing region R. By covering most of the surface regions of the magnetic block 2 with the element body material in this way, the thermal expansion of the magnetic block 2 is effectively suppressed, and the occurrence of cracks generated in the element body 90 due to the thermal expansion of the magnetic block 2 is suppressed.

The thickness T1 of the element body material in the gap G may be equal to or greater than the thickness T2 of the element body material covering the main surface 2a of the magnetic block 2 (T1 ≥ T2), and in this case, by filling the gap G with the element body material having a sufficient thickness, the occurrence of the crack 92 is more reliably suppressed.

The thickness T1 of the element body material in the gap G may be thinner than the thickness T2 of the element body material covering the main surface 2a of the magnetic block 2 (T1 < T2), and in this case, high strength can be secured on the first side surface 90a side of the element body 90, and the situation where a crack occurs in the first side surface 90a of the element body 90 is suppressed.

When the thickness T1 of the element body material in the gap G is equal to or greater than the thickness t of the terminal portions 7A and 7B and equal to or less than the thickness T3 of the element body material covering the upper surface 2e of the magnetic block 2, the occurrence of the crack 92 can be more reliably suppressed by filling the gap G with the element body material having a sufficient thickness, and an increase in the product size of the inductor 1 more than necessary is suppressed.

When the thickness of the element body material covering the remaining region of the facing region R facing the coil conductor 3 of the surface regions of the magnetic block 2 is thicker than the thickness T1 of the element body material in the gap G, the element body 90 having high strength can be realized.

In the inductor 1, the coil conductor 3 includes the pair of conductor portions 4A and 4B and the connection conductor portion 6, and the pair of terminal portions 7A and 7B extend from the respective end portions on the lower surface 90f side of the conductor portions 4A and 4B of the coil conductor 3. Therefore, two terminals can be formed on the lower surface 90f of the element body 90.

The upper surface 2e of the magnetic block 2 is located closer to the lower surface 90f side than the surface on the lower surface 90f side of the connection conductor portion 6. In this case, since the magnetic block 2 is less likely to obstruct the magnetic flux around the connection conductor portion 6, the inductance is improved. Further, when molding the element body 90 using a paste-like element body material, the magnetic block 2 is less likely to obstruct the inflow of the element body material into the space defined by the conductor portions 4A and 4B of the coil conductor 3 and the connection conductor portion 6, and the space can be more reliably filled with the element body material.

In the inductor 1, since the second magnetic block 2B is provided in the element body 90 so as to sandwich the first coil conductor 3A with the first magnetic block 2A in addition to the first magnetic block 2A, the inductance is further improved.

The lower surface 2f of the second magnetic block 2B may be located closer to the upper surface 90e side than the upper surfaces 7b of the terminal portions 7A and 7B.

Regarding the upper surface 2e of the second magnetic block 2B as well, similarly to the upper surface 2e of the first magnetic block 2A, it may be located closer to the lower surface 90f side than the surface on the lower surface 90f side of the connection conductor portion 6 of the first coil conductor 3A. In this case, since the second magnetic block 2B is less likely to obstruct the magnetic flux around the connection conductor portion 6 of the first coil conductor 3A, the inductance is improved. Further, when molding the element body 90 using a paste-like element body material, the second magnetic block 2B is less likely to obstruct the inflow of the element body material into the space defined by the conductor portions 4A and 4B of the first coil conductor 3A and the connection conductor portion 6, and the space can be more reliably filled with the element body material.

The upper surface 2e of the first magnetic block 2A may be located closer to the upper surface 90e side than the upper surface 2e of the second magnetic block 2B, and the lower surface 2f of the second magnetic block 2B may be located closer to the lower surface 90f side than the lower surface 2f of the first magnetic block 2A. Regarding the length in the Z-axis direction (i.e., height), when the length of the first magnetic block 2A and the length of the second magnetic block 2B are the same or comparable, the first magnetic block 2A may be shifted to the upper surface 90e side with respect to the second magnetic block 2B.

The insulation layer 8 is interposed between the upper surfaces 7b of the terminal portions 7A and 7B and the element body material filling the gap G. The insulation layer 8 suppresses the situation where solder wraps around to the upper surfaces 7b of the terminal portions 7A and 7B during reflow.

The peel strength at the interface between the insulation layer 8 and the element body material may be higher than the peel strength at the interface between the insulation layer 8 and the terminal portions 7A and 7B. In this case, the terminal portions 7A and 7B are easily fixed by the element body material, and the strength is improved.

Since the element body material constituting the element body 90 of the inductor 1 is a magnetic resin containing a magnetic material such as soft magnetic metal powder, the inductance is improved as compared with an element body material containing no magnetic material. At this time, the permeability of the magnetic block 2 may be higher than the permeability of the element body material.

The thermal expansion coefficient in the Z-axis direction of the magnetic block 2 is larger than the thermal expansion coefficients in the X-axis direction and the Y-axis direction. In this case, since the gap G overlapping with the magnetic block 2 in the Z-axis direction is filled with the element body material, the crack 92 due to the thermal expansion in the Z-axis direction of the magnetic block 2 is effectively suppressed.

The inductor 1 includes the second coil conductor 3B provided in the element body 90 and sandwiching the second magnetic block 2B with the first coil conductor 3A in the X-axis direction, the third magnetic block 2C provided in the element body 90 and sandwiching the second coil conductor 3B with the second magnetic block 2B in the X-axis direction, and having a first surface facing the first side surface side and a second surface facing the second side surface side which face each other in the first direction, and a third surface facing the first main surface side and a fourth surface facing the second main surface side which face each other in the second direction, and the terminal portions 7A and 7B extending from the end portions on the lower surface 90f side of the conductor portions 4A and 4B of the second coil conductor 3B to the second side surface 90b side of the element body 90 to face the lower surface 2f of the third magnetic block 2C, and the gap G between the lower surface 2f of the third magnetic block 2C and the terminal portions 7A and 7B is filled with the element body material constituting the element body 90. Therefore, under a situation where the third magnetic block 2C thermally expands in the Z-axis direction under a high-temperature environment, the third magnetic block 2C does not directly press the terminal portions 7A and 7B of the second coil conductor 3B downward, and the situation where the above-described crack 92 occurs in the element body 90 is suppressed.

The upper surface 2e of the third magnetic block 2C may be located closer to the upper surface 90e side than the upper surface 2e of the second magnetic block 2B, and the lower surface 2f of the second magnetic block 2B may be located closer to the lower surface 90f side than the lower surface 2f of the third magnetic block 2C. Regarding the length in the Z-axis direction (i.e., height), when the length of the third magnetic block 2C and the length of the second magnetic block 2B are the same or comparable, the third magnetic block 2C may be shifted to the upper surface 90e side with respect to the second magnetic block 2B.

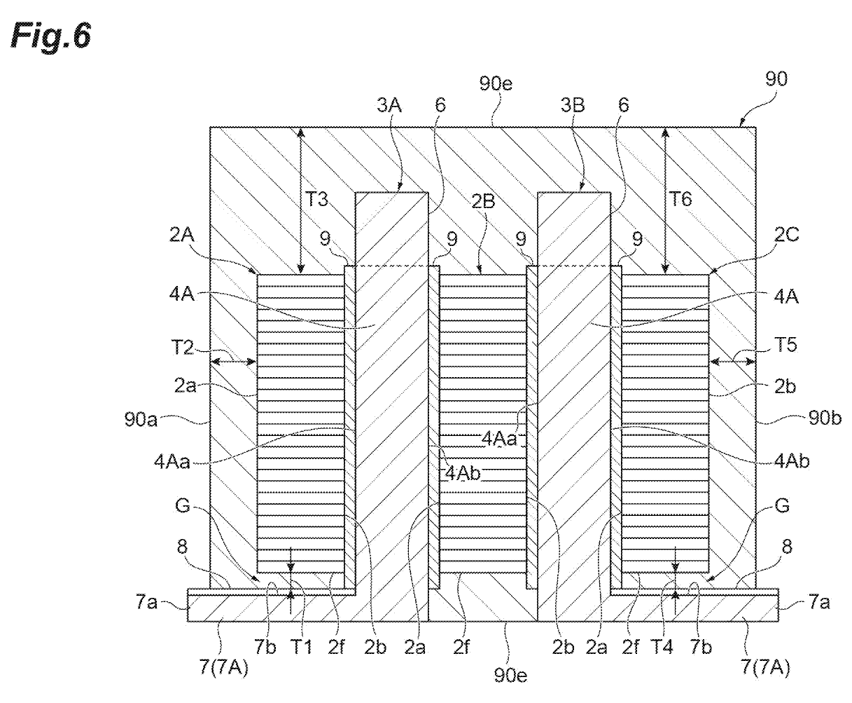

The third magnetic block 2C does not necessarily have to be shifted to the upper surface 90e side with respect to the second magnetic block 2B. The first magnetic block 2A also does not necessarily have to be shifted to the upper surface 90e side with respect to the second magnetic block 2B. For example, as shown in FIG. 6, the first magnetic block 2A, the second magnetic block 2B, and the third magnetic block 2C may be at the same position with respect to the Z-axis direction. In this case, the magnetic blocks 2A to 2C may be arranged at the same position in the Y-Z plane such that the end surfaces and the side surfaces overlap each other when viewed from the X-axis direction. A positional deviation within a range caused by manufacturing error or the like is included in the "same position".

The present disclosure is not limited to the above-described embodiments. Although the inductor according to the above-described embodiment includes two coil conductors, the number of coil conductors is not particularly limited, and may be one, or may be three or more. Further, although the inductor according to the above-described embodiment includes three magnetic blocks, the number of magnetic blocks 2 may be one, two, or four or more.

What is claimed is:

1. An inductor comprising:
an element body having a first side surface and a second side surface facing each other in a first direction, and a first main surface and a second main surface facing each other in a second direction orthogonal to the first direction, and composed of an element body material containing resin;
a first magnetic body provided in the element body and having a first surface and a second surface facing each other in the first direction, and a third surface and a fourth surface facing each other in the second direction, the first surface faces the first side surface side, the second surface faces the second side surface side, the third surface faces the first main surface side, and the fourth surface faces the second main surface side;
a first coil conductor provided in the element body, at least a part of the first coil conductor faces the second surface of the first magnetic body; and
a first terminal portion extending from an end portion on the first main surface side of the first coil conductor to the first side surface side to face the third surface of the first magnetic body, and at least a part of the first terminal portion is exposed from the first main surface of the element body,
wherein a gap between the third surface of the first magnetic body and the first terminal portion is filled with the element body material.

2. The inductor according to claim 1, wherein the element body material covers a remaining region of a region facing the first coil conductor in the second surface of surface regions of the first magnetic body.

3. The inductor according to claim 2, wherein a length in the second direction of the element body material in the gap between the third surface of the first magnetic body and the first terminal portion is equal to or greater than a length in the first direction of the element body material covering the first surface of the first magnetic body.

4. The inductor according to claim 2, wherein a length in the second direction of the element body material in the gap between the third surface of the first magnetic body and the first terminal portion is shorter than a length in the first direction of the element body material covering the first surface of the first magnetic body.

5. The inductor according to claim 2, wherein a length in the second direction of the element body material in the gap between the third surface of the first magnetic body and the first terminal portion is equal to or greater than a length in the second direction of the first terminal portion, and is equal to or less than a length in the second direction of the element body material covering the fourth surface of the first magnetic body.

6. The inductor according to claim 2, wherein a thickness of the element body material covering a remaining region of a region facing the first terminal portion in the third surface of surface regions of the first magnetic body is thicker than a thickness of the element body material covering the region facing the first terminal portion in the third surface of the first magnetic body.

7. The inductor according to claim 1, wherein the first coil conductor includes a first conductor portion and a second conductor portion extending in the second direction and facing the second surface of the first magnetic body, and a connection conductor portion connecting the first conductor portion and the second conductor portion, and a pair of the first terminal portions extend from respective end portions on the first main surface side of the first conductor portion and the second conductor portion of the first coil conductor.

8. The inductor according to claim 7, wherein the fourth surface of the first magnetic body is located closer to the first main surface side than a surface on the first main surface side of the connection conductor portion.

9. The inductor according to claim 7, further comprising a second magnetic body provided in the element body and sandwiching the first coil conductor with the first magnetic body in the first direction, wherein the second magnetic body has a first surface facing the first side surface side and a second surface facing the second side surface side which face each other in the first direction, and a third surface facing the first main surface side and a fourth surface facing the second main surface side which face each other in the second direction, and the first conductor portion and the second conductor portion of the first coil conductor face the first surface of the second magnetic body.

10. The inductor according to claim 9, wherein the third surface of the second magnetic body is located closer to the second main surface side than a facing surface of the first terminal portion facing the first magnetic body in the second direction.

11. The inductor according to claim 9, wherein the fourth surface of the second magnetic body is located closer to the first main surface side than a surface on the first main surface side of the connection conductor portion.

12. The inductor according to claim 9, wherein the fourth surface of the first magnetic body is located closer to the second main surface side than the fourth surface of the second magnetic body, and the third surface of the second magnetic body is located closer to the first main surface side than the third surface of the first magnetic body.

13. The inductor according to claim 1, wherein an insulation layer is interposed between the element body material and a facing surface of the first terminal portion facing the first magnetic body in the second direction.

14. The inductor according to claim 13, wherein a peel strength at an interface between the insulation layer and the element body material is higher than a peel strength at an interface between the insulation layer and the first terminal portion.

15. The inductor according to claim 1, wherein the element body material is a magnetic resin containing a magnetic material.

16. The inductor according to claim 15, wherein a permeability of the first magnetic body is higher than a permeability of the magnetic resin.

17. The inductor according to claim 1, wherein a thermal expansion coefficient in the second direction of the first magnetic body is larger than thermal expansion coefficients in the first direction and a third direction orthogonal to the first direction and the second direction.

18. The inductor according to claim 9, further comprising:
a second coil conductor provided in the element body, sandwiching the second magnetic body with the first coil conductor in the first direction, and at least a part of which faces the second surface of the second magnetic body;
a third magnetic body provided in the element body, sandwiching the second coil conductor with the second magnetic body in the first direction, and having a first surface facing the first side surface side and a second surface facing the second side surface side which face each other in the first direction, and a third surface facing the first main surface side and a fourth surface facing the second main surface side which face each other in the second direction; and
a second terminal portion extending from an end portion on the first main surface side of the second coil conductor to the second side surface side to face the third surface of the third magnetic body, and at least a part of which is exposed from the first main surface of the element body,
wherein a gap between the third surface of the third magnetic body and the second terminal portion is filled with the element body material.

19. The inductor according to claim 18, wherein the fourth surface of the third magnetic body is located closer to the second main surface side than the fourth surface of the second magnetic body, and the third surface of the second magnetic body is located closer to the first main surface side than the third surface of the third magnetic body.

20. A DC-DC converter comprising the inductor according to claim 1
.
